(19) United States
(12) Patent Application Publication
(10) Pub. No.: US 2026/0327126 A1
(43) Pub. Date: Oct. 22, 2026

(54) GREENHOUSE GLAZING

(71) Applicant: AGC GLASS EUROPE, Louvain-la-Neuve (BE)

(72) Inventors: Seyedmohammad SHAYESTEHAMINZADEH, Gosselies (BE); Daphné STASSEN, Gosselies (BE); Fabrice DUFOUR, Gosselies (BE)

(73) Assignee: AGC GLASS EUROPE, Louvain-la-Neuve (BE)

(21) Appl. No.: 19/117,524

(22) PCT Filed: Oct. 2, 2023
(86) PCT No.: PCT/EP2023/077289

§ 371 Date: Apr. 1, 2025

(30) Foreign Application Priority Data
Oct. 6, 2022 (EP) 22200092

(51) Int. Cl. C03C 17/36; A01G 9/14; C03C 15/00; C03C 17/34

(52) U.S. Cl. CPC C03C 17/3636; A01G 9/1469; C03C 15/00; C03C 17/3423; C03C 17/3644; C03C 2204/08; C03C 2217/212; C03C 2217/213; C03C 2217/216; C03C 2217/256; C03C 2217/732

(57) ABSTRACT

A double glazing for greenhouses which are designed to fit a cold climate. The double glazing have a good insulation ability (low U value) and keep a high PAR transmittance. The hortiscatter may be adjusted due to the roughness of the tin side glass surface.

### TECHNICAL FIELD

The present invention relates to isolating double glazing unit (IGU) for greenhouses. The double glazing unit of the invention is characterized through a low thermal coefficient U together with a sufficient PAR light transmission (T_{PAR}).

### BACKGROUND ART

For an optimal plant growth in a greenhouse, some requirements need to be fulfilled. Namely the plants must receive enough light well distributed all over the greenhouse volume, along with a specific homogeneous temperature range, as well as enough carbon dioxide and humidity. More particularly, the PAR light, corresponding to a wavelength between 400 and 700 nm is the light responsible for crop growth and specific attention has to be taken into account to keep the amount of this part of light distributed inside the greenhouse as big and as homogeneous as possible.

In cold climate, the inside temperature of the greenhouse may decrease dramatically because of thermal energy losses through the glass due to poor thermal insulation i.e. high emissivity of normal soda lime glass. To maintain production, heating is requested to avoid all problems associated with the temperature decrease, as for example water condensation on structural surface and on the plant leaves.

To avoid heat loss, the immediate answer is insulation. Since a greenhouse is mainly a glass construction, a good chance to decrease the heat loss is to decrease the thermal transmittance thanks to double glazing structure and/or solar control coatings. Some old patents like GB2022671A, GB2094383B or DE2532633B1 have already proposed a greenhouse including double glazing. Nevertheless very few users have chosen such kind of structure. There are mainly two reasons for the poor success of double glazed greenhouses. First such construction are very expensive but above all, light reflection is increased and light transmission drastically decreased. A lower PAR light transmission results in a lower yield of plants crops. As a consequence, using a double glazing may be more or less advantageous in cases where heating the greenhouse is an obligation. This allow to decrease the heating costs despite the double glazing will induce some big loss in light transmittance and more particularly in PAR light transmittance, and then also, in crop yield.

The current environmental problem makes people in all sectors consider the question of carbon dioxide release. A bad insulation for a greenhouse will result in an higher heating need and as a final consequence a higher carbon dioxide release. This is why double glazing unit is becoming a valuable answer. The present invention is proposing a solution to use double glazing for greenhouse in which the double glazing unit, allowing a better insulation, is also designed to avoid as much as possible a loss in PAR light transmission.

### OBJECT OF THE INVENTION

The objective of the invention is to design a double glazing unit suitable for the construction of a greenhouse fitted for cold climate. The double glazing unit for the greenhouse must have higher insulation characteristics combined with a good PAR light transmittance. The first characteristic will allow to decrease the heating needs and as a consequence the carbon dioxide release together with the costs, while the second characteristic will contribute to maintain a sufficient crop yield. For safety reasons, the glazing needs to be tempered.

The inventors have found that the objective can be reached thanks to a double glazing unit for a greenhouse, comprising an outside glass substrate (GL1) with 2 main surfaces referenced as P1 and P2 and an inside glass substrate (GL2) with 2 main surfaces referenced as P3 and P4 wherein, the P4 main surface of the inside glass substrate is characterized through a specific roughness and is preferably coated with an antireflective layer, said specific roughness is characterized by a Sa parameter comprised between 0.18 and 1.80 μm, a Sz parameter comprised between 1.5 and 10.0 μm and a Rsm parameter comprised between 65 and 125 μm.

Preferably, the antireflective layer is a nano-porous silica layer having a thickness comprised between 80 and 150 nm, preferably between 100 and 120 nm and has a refractive index of at most 1.5, preferably at most 1.4 and more preferably at most 1.38.

More particularly, the specific roughness is characterized by
the parameter Sa being at least 0.18 μm, preferably at least 0.19 μm, more preferably at least 0.20 μm and being at most 1.8 μm, preferably at most 1.7 μm, more preferably at most 1.6 μm,
the parameter Sz being at least 2 μm, preferably at least 2.5 μm, more preferably at least 3 μm and being at most 10.0 μm, preferably at most 9.5 μm, more preferably at most 9.0 μm,
the parameter Rsm being at least 65 μm, preferably at least 70 μm, more preferably at least 75 μm and being at most 125 μm, preferably at most 120 μm, more preferably at most 115 μm.

Alternatively a second antireflective layer is deposited on the P1 main surface, this second antireflective layer being a nano-porous silica layer having a thickness comprised between 80 and 150 nm, preferably between 100 and 120 nm and has refractive index of at most 1.5, preferably at most 1.4 and more preferably at most 1.38.

Alternatively, a third antireflective layer is deposited on the P2 main surface, this third antireflective layer being a nano-porous silica layer having a thickness comprised between 80 and 150 nm, preferably between 100 and 120 nm and has refractive index of at most 1.5, preferably at most 1.4 and more preferably at most 1.38.

Alternatively, all main surfaces P1, P2, P3 and P4 are coated with an antireflective layer, each antireflective layer being a nano-porous silica layer having a thickness comprised between 80 and 150 nm, preferably between 100 and 120 nm and has refractive index of at most 1.5, preferably at most 1.4 and more preferably at most 1.38.

Alternatively, for any of the embodiment, the P3 main surface is coated with a low-e stack comprising successively from the glass surface, a first dielectric film, a silver layer and a second dielectric film.

For all embodiments, the inventors have observed that it is possible to increase the PAR transmittance while keeping the thermal coefficient U expressed in W/m²·K unchanged. This increase is at least 1.5% and preferably at least 2.0%, compared to the glazing without antireflective coating. These values are absolute and not relative.

### SUMMARY OF INVENTION

The present inventors have found a very good compromise to have a good PAR light transmittance together with a good thermal insulation. We here describe a double glazing unit comprising two glass substrates which have particular characteristics. Both glass substrates are clear or preferably extra-clear glass substrates and for safety reason, both glass substrates are heat strengthened, so-called thermally tempered.

In a first embodiment, the external side of the inside glass substrate (P4) of the double glazing unit of the invention has a particular texturing. The particular texturing has no regular pattern but rather a random morphology which is better described through its roughness parameter Sa, Sz and Rsm. This particular texturing will be better described below.

In a first mode of a first embodiment, the external side of the inside glass substrate (P4) of the double glazing unit has a particular texturing and is coated with an antireflective coating (FIG. 3a).

In a second mode of the first embodiment, the external side of the inside glass substrate (P4) of the double glazing unit has a particular texturing and both the external side of the inside glass substrate (P4) and the external side of the outside glass substrate (P1) of the double glazing unit are coated with an antireflective coating (FIG. 3b).

In a third mode of the first embodiment, the external side of the inside glass substrate (P4) of the double glazing unit has a particular texturing and external sides of the inside and outside glass substrates (P4 and P1, respectively) of the double glazing unit and the internal side of the outside glass substrate (P2) of the double glazing unit are coated with an antireflective coating (FIG. 3c).

In a fourth mode of the first embodiment, the external side of the inside glass substrate (P4) of the double glazing unit has a particular texturing and all glass sides of the inside and outside glass substrates (P1, P2, P3, P4) are coated with an antireflective coating (FIG. 3d).

In a second embodiment, the external side of the inside glass substrate (P4) of the double glazing unit has a particular texturing and the internal side of the inside glass substrate (P3) of the double glazing unit is coated with a low-e stack.

In a first mode of the second embodiment, the external side of the inside glass substrate (P4) of the double glazing unit has a particular texturing, the internal side of the inside glass substrate (P3) of the double glazing unit is coated with a low-e stack and the external side of the inside glass substrate (P4) of the double glazing unit is coated with an antireflective layer (FIG. 4a).

In a second mode of the second embodiment, the external side of the inside glass substrate (P4) of the double glazing unit has a particular texturing, the internal side of the inside glass substrate (P3) of the double glazing unit is coated with a low-e stack and both the external side of the inside glass substrate (P4) of the double glazing unit and the external side of the outside glass substrate (P1) of the double glazing unit are coated with an antireflective layer (FIG. 4b).

In a third mode of the second embodiment, the external side of the inside glass substrate (P4) of the double glazing unit has a particular texturing, the internal side of the inside glass substrate (P3) of the double glazing unit is coated with a low-e stack and the external side of the inside glass substrate (P4) of the double glazing unit and both the external and the internal sides of the outside glass substrate (P1 and P2, respectively) of the double glazing unit are coated with an antireflective layer (FIG. 4c).

For any mode of any embodiment of the invention, said particular texturing of the external side of the inside glass substrate (P4) of the double glazing unit has a roughness characterized by the Sa parameter comprised between 0.18 and 1.80 μm, a Sz parameter comprised between 1.5 and 10 μm and a Rsm parameter comprised between 65 and 125 μm.

For any mode of any embodiment of the invention, said particular texturing of the external side of the inside glass substrate (P4) of the double glazing unit has a Sa parameter being at least 0.185 μm, preferably at least 0.19 μm, more preferably at least 0.20 μm and being at most 1.8 μm, preferably at most 1.7 μm, more preferably at most 1.6 μm.

For any mode of any embodiment of the invention, said particular texturing of the external side of the inside glass substrate (P4) of the double glazing unit has a Sz parameter being at least 2.0 μm, preferably at least 2.5 μm, more preferably at least 3.0 μm and being at most 10.0 μm, preferably at most 9.5 μm, more preferably at most 9.0 μm.

For any mode of any embodiment of the invention, said particular texturing of the external side of the inside glass substrate (P4) of the double glazing unit has a Rsm parameter being at least 65 μm, preferably at least 70 μm, more preferably at least 75 μm and being at most 125 μm, preferably at most 120 μm, more preferably at most 115 μm.

For any mode of any embodiment of the invention, the antireflective coating is advantageously a nano-porous silica layer (a) having preferably a thickness of from 80 nm to 150 nm, preferably of from 100 nm to 120 nm. Preferably the nano-porous silica layer has refractive index of at most 1.5, preferably at most 1.4 and more preferably at most 1.38.

For any mode of the second embodiments, said low-e stack may be any low-e known from the man in the art, and preferably, said low-e comprises a silver layer deposited between two dielectric films, and preferably said silver layer is the only silver layer of the stack. Preferably the low-e comprises a single silver stack.

For any mode of any mode of the first embodiment of the invention, the PAR transmittance is greater than 86.3%, preferably greater than 90.8% and more preferably greater than 93.2%.

For any mode of any mode of the second embodiment of the invention, the PAR transmittance is greater than 82.7%, preferably greater than 83.9% and more preferably greater than 85.0%.

For any mode of any embodiment, the hortiscatter of the double glazing unit of the invention is comprised between 5 and 70%, preferably between 10 and 65% and more preferably between 14 and 63%.

For any mode of the first embodiment, the thermal coefficient U expressed in W/m²·K, for the double glazing unit of the invention is below 3, preferably below 2.65.

For any mode of the second embodiment, the thermal coefficient U expressed in W/m²·K, for the double glazing unit of the invention is below 2, preferably below 1.6 and more preferably below 1.5 and even more preferably below 1.2.

For all embodiments, the glass substrates are advantageously made of clear glass and even more advantageously of extra-clear glass.

Another advantage for any mode of any embodiment of the glazing of the invention is that thanks to the combined parameters, we observe a good hydrophilicity for the glass surface characterized through the particular texturing defined above. As a consequence of this hydrophilicity, condensation of water occurs as a film instead of droplets.

The existence of the hortiscatter is due to the presence of special microstructure implemented by the particular texturing of the glass surface while the antireflective coating is responsible for a higher PAR transmission, a higher hydrophilicity and a better resistance to corrosion. The hortiscatter allows a more homogeneous light distribution inside the greenhouse and thus avoid shadowing effect or hot points to a too large extend. More particularly the roughness issued from a random texturing is responsible for a good light distribution inside the greenhouse.

In the case of the second embodiment, one must be conscious that the UV light is drastically decreased. This can be advantageous or disadvantageous depending the plant crop considered.

The double glazing unit of the invention present a good durability. Moreover the nano-porous silica layer is also protecting the textured surface from corrosion by acting as diffusion barrier for volatile species inside the core glass, giving enhanced chemical and mechanical durability which enable the longer performance with the minimized deterioration rate, being in line with class A coating based on the norm EN 1096-2 (2012-E)

### BRIEF DESCRIPTION OF DRAWINGS

This and other aspects of the present invention will now be described in more detail, with reference to the appended drawings and by showing various exemplifying embodiments of the invention.

FIG. 1 shows different types of glass substrates:

1a is a monolithic glass substrate without any treatment nor coating,

1b is a glass substrate with one side comprising the particular texturing of the invention;

1c is a glass substrate with one side comprising the particular texturing of the invention and an antireflective coating;

1d is a glass substrate with one side comprising the particular texturing of the invention and a low-e stack on the opposite side and

1e is a glass substrate with one side comprising the particular texturing of the invention and an antireflective coating and a low-e stack on the opposite side.

FIG. 2 illustrates a double glazing unit with the external glass substrate I (or GL1), facing the sun and the internal glass substrate II (or GL2). The drawing indicates how the different sides of the glass substrates are identified (P1 to P4).

FIG. 3 shows the first mode (3a), second mode (3b), third mode (3c) and fourth mode (3d) of the first embodiment of the invention.

FIG. 4 shows the first mode (4a), the second mode (4b) and the third mode (4c) of the second embodiment of the invention.

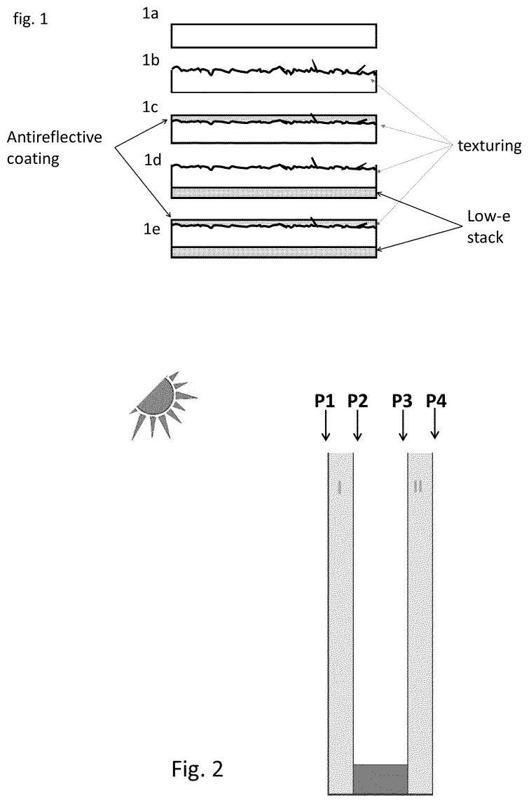

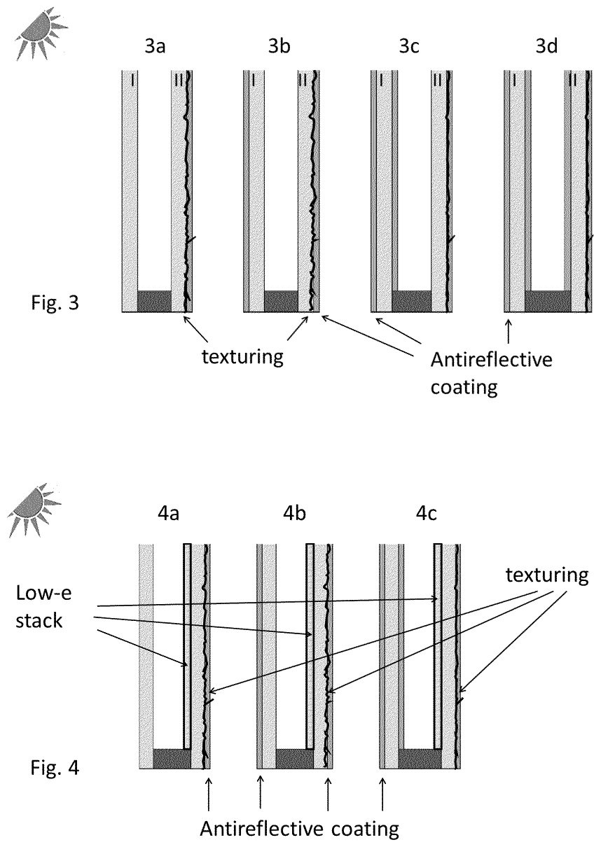

### DESCRIPTION

The features of our invention are the consequence of a combination of 1°) glass quality, 2°) glass surface treatment to reach the specific texturing of the invention and so, have the desired hortiscatter and 3°) antireflective coatings with or without a low-emissive coating. Each of those characteristics will now be described with more details.

### Definitions

By inside glass substrate, here and for all the text, we mean the substrate facing the inside of the greenhouse. The outside glass substrate is the substrate facing the outside of the greenhouse (regarding the sun). Considering the substrates of the double glazing unit, external side means both sides opposite to the space between the two glass substrates (P1 and P4) while internal side means the side facing the space between the two glass substrates (P2 and P3). In other words, P1 is the side facing the sun and P4 is the side facing the plants. For the entire text, glass main surface may be designated by glass side, glass face or glass surface in an equivalent manner.
When a specific range is given for a particular characteristic, we consider the limits of this range is part of it, if there is no particular indication.
Double glazing unit or double glazing are equivalent wording.
PAR meaning is Photosynthetically Active Radiation and comprises wavelength between 400 to 700 nm, based on NEN 2675+C1: 2018. This is the main part of natural light responsible for photosynthetic activities of plants.
Within the context of horticulture, hortiscatter is the integral value of geometrical distribution of light intensity by bi-directional transmittance (or reflectance) distribution function BTDF under a given angle of incidence of incoming light beam (3D data), defined by Wageningen University and Research (WUR) in the standard NEN 2675+C1: 2018.
Hemispherical light transmission (Tₕₑₘ) is measured following the standard NEN 2675+C1: 2018. The hemispherical light transmission is a measure of light transmission at different angles from the point of light incidence.
The refractive index n is calculated from the light spectrum wavelength at 550 nm.
When roughness is considered, for the purpose of the invention, the latter is characterized through the Sa, Sz and Rsm values (expressed in micrometers without any other precision). The roughness parameters were measured by confocal microscopy. The surface parameters (Sa and Sz) according to ISO 25178 standard (part 2 and part 3, 2012F), and the profile parameter (Rsm) by isolating a 2D profile which then gives access to the parameters defined in the ISO 4287-1997 standard. Alternatively, one can use a 3D profilometer for the surface parameters (according to the ISO 25178 standard, part 2 and part 3, 2012F) and a 2D profilometer for the profile parameters (according to the ISO 4287-1997 standard). The texture/roughness is a consequence of the existence of surface irregularities/patterns. These irregularities consist of bumps called “peaks” and cavities called “valleys”. On a section perpendicular to the etched surface, the peaks and valleys are distributed on either side of a “center line” (algebraic average) also called “mean line”. In a profile and for a measurement along a fixed length (called “evaluation length”).
   Sa (arithmetic mean height) expresses, as an absolute value, the difference in height of each point compared to the arithmetical mean of the surface, the Sa parameter is characterized by a standard deviation of 0.1 μm;
   Sz (maximum height) is defined as the sum of the largest peak height value and the largest pit depth value within the defined area, the Sz parameter is characterized by a standard deviation of 0.6 μm;
   Rsm (spacing value, sometimes also called Sm) is the average distance between two successive passages of the profile through the “mean line”; and this gives the average distance between the “peaks” and therefore the average value of the widths of the patterns, the Rsm parameter is characterized by a standard deviation of 1.0 μm.
The water contact angle is the angle made between the tangent to a water drop and the surface of the support. The measure is made following the standard method ASTM C 813-75 (1989)
All measures are given for the tempered glasses or glazing.

The glazing of the invention is a class A certified coated glazing, the certification is conform to the norm EN1096-2 2012E.

The glass substrates used to build the double glazing of the invention is a clear or preferably an extra-clear glass that intrinsically allows a good light transmittance. By clear glass, one should understand that the glass substrate has a composition characterized by an iron content expressed in weight percent of Fe₂O₃ which is at most 0.1%. This value drops to at most 0.015% for the extra clear glass. More preferably the glass substrates of the invention have a thickness of at least 1 mm, preferably at least 2 mm and more preferably at least 3 mm and at most 6 mm, preferably at most 5 mm and more preferably at most 4.5 mm.

As presented before, the external side of the inside glass substrate (P4) of the double glazing unit has a particular texturing having a roughness characterized by the Sa parameter comprised between 0.18 and 1.8 μm, a Sz parameter comprised between 1.5 and 10.0 μm and a Rsm parameter comprised between 65 and 125 μm.

According to the invention, to reach the desired roughness, any known method such as mechanical or chemical process may be convenient as far as the correct roughness is reached. In a preferred embodiment, texturing is obtained by means of a controlled chemical attack. More particularly, the chemical attack is performed with an aqueous solution based on hydrofluoric acid, carried out one or more times. Generally, the aqueous acidic solutions used for this purpose have a pH between 0 and 5 and they can comprise, in addition to the hydrofluoric acid itself, salts of this acid, other acids, such as HCl, H₂SO₄, HNO₃, acetic acid, phosphoric acid and/or their salts (for example, Na₂SO₄, K₂SO₄, (NH₄)₂SO₄, BaSO₄, and the like), and also other adjuvants in minor proportions. Alkali metal and ammonium salts are generally preferred, such as, for example, sodium, potassium and ammonium bifluoride. The acid etching stage according to the invention can advantageously be carried out by a controlled acid attack, for a time which can vary as a function of the acid solution used and of the expected etched surface result.

According to a particular aspect of the invention, the antireflective coating of the invention is a nano-porous silica layer (a) having a thickness of from 80 nm to 150 nm, preferably of from 100 nm to 120 nm. Advantageously, the nano-porous silica layer deposition is performed through a PECVD process as described in EP1679291B1 and incorporated here by reference. The nano-porous SiOₓ film will get its final optical and mechanical properties in a two-step production. At first, in the as-deposited state the thin film is coated by a PECVD process and results in high carbon content SiOₓC_{y} coating, the layer comprises 5 to 30 at. % of Silicon, 20 to 60 at. % of Oxygen, 2 to 30 at. % of carbon and 2 to 30 at. % of hydrogen. In order to get the final optical and mechanical properties one needs to bake the glass and the film. The carbon is desorbed during the tempering process leaving increased porosity, pores having a mean diameter greater than 5 nm. Increasing porosity results in a smaller refractive index, responsible for the antireflective performance. Preferably, after tempering, the refractive index of the SiOₓ layer is at most 1.5, preferably at most 1.4 and more preferably at most 1.38. Temperatures for any heat strengthened glass are between 650° C.-680° C. Advantageously, the final refractive index is 1.37. Based on the special plasma process the surface of the glass together with the coating will be densified. The chemical bond between the Si group in the coating and the Si group on the surface of the glass at the interface of coating-glass surface is the main reason on the better mechanical durability performances. Furthermore regarding the mechanical behaviour, the coating after bake is harder than the uncoated float glass for both sides.

The inventors have discovered that by adding such nano-porous silica layer on the textured P4 side of the internal glass substrate, the PAR transmittance (T_{PAR}) increase of at least 1.5% and more preferably of at least 2.0% is achieved, as compared to the non-coated glass. When the nano-porous silica layer is deposited on both P4 and P1 sides, the PAR transmittance (T_{PAR}) increase of at least 3.5% preferably at least 4.3% is achieved versus the non-coated glass. When the nano-porous silica layer is deposited on P1, P2 and P4 sides, the PAR transmittance (T_{PAR}) increase of at least 5.4% preferably at least 6.2% is achieved versus the non-coated glass and when the nano-porous silica layer is deposited on all P1, P2, P3, and P4 sides, the PAR transmittance (T_{PAR}) increase of at least 8.0% preferably at least 8.9% is obtained.

When still a higher thermal insulation is needed, the internal side of the inside glass substrate (P3) is coated with a low-emissive stack. The low-emissive stack of the second embodiment of the invention may be any low-emissive stack well known by the man of the art as far as this stack is not affecting the PAR light transmission in a too large extend. Namely, the difference between the PAR light transmission of the first embodiment and the PAR light transmission of the second embodiment must be lower than 4.5%, preferably lower than 4% and more preferably lower than 3.5% (for equivalent modes).

According to the second embodiment of the invention, advantageously, the low-emissive coating comprises a single silver, the silver layer has a geometric thickness of at least 7 nm, preferably at least 8 nm and more preferably at least 9 nm. The geometric thickness of silver layer is at most 16 nm, preferably at most 14 nm and more preferably at most 12 nm.

According to the second embodiment of the invention, the silver layer is deposited above a first dielectric coating and below a second dielectric coating. Advantageously, the silver layer is deposited directly above a zinc oxide layer. Advantageously a protecting layer is deposited directly above the silver layer. The protecting may be any protecting layer known in the art, but preferably, the protecting layer is a zinc oxide layer.

According to any embodiment of the invention, the two glass substrates of the invention are assembled in a well-known manner to constitute a double glazing unit.

### DESCRIPTION OF EMBODIMENTS/EXAMPLES

For the examples of the invention, the glass substrate is a 4 mm tempered extra-clear glass. The glass substrate has been washed with deionized water and then dried. One side of the glass substrate is then treated at 20-25° C. with an acid etching solution, composed by volume of 50% NH₄HF₂, 25% water, 6% concentrated H₂SO₄, 6% of a 50% by weight aqueous HF solution, 10% K₂SO₄ and 3% (NH₄)₂SO₄. The etching solution was allowed to contact the glass surfaces for 1.5 minutes. After removal of the etching solution, the glass surface has been rinsed with water and washed. For this particular example, the resulting roughness is characterized by a Sa value of 0.65 μm, a Sz value of 5.57 μm and a Rsm value of 78 μm.

After the etching treatment, the glass substrate has been transferred to a coating unit and a nano-porous silica layer has been deposited on the textured side thanks to the process described above ([0052]).

In a similar way, depending the case the same nano-porous silica layer may be or not deposited on the other side of the textured glass substrate.

In a similar way, the same nano-porous silica layer may be or not deposited on one or both sides of a non-textured glass substrate.

Alternatively, after the etching treatment and the deposition of the nano-porous silica layer on the textured side, the glass substrate is transferred to a PVD coating unit and the following layers are successively deposited on the opposite side of the textured surface, in a way very well known by the man skill in the art:
GL/TiO2 (22)/ZnO (3)/Ag (11.8)/AZO (3)/TiO2 (10)/ZSO5 (12)/SiN (18)

Figures in parentheses are indicating the geometric thickness (expressed in nm), AZO means a zinc oxide layer from a ceramic target comprising zinc oxide and aluminum oxide. ZSO5 is a tin zinc oxide layer corresponding to the zinc stannate. This particular stack has been used for the examples but is by no way limiting.

Double glazing units have been assembled using different configurations in terms of specific glass surface but for all example, the double glazing unit has the following structure: GL1 (4 mm)/space (12 mm, fill with argon)/GL2 (4 mm). The double glazing unit is a assembled through a known manner by the man skill in the art. The table 1 summarizes the configuration corresponding to the examples of the invention. The columns 2 to 4 design the glass surface that is etched (column 2), coated with a nano-porous silica layer (AR for antireflective, column 3) or coated with a low-e (column 4). The two last columns give the performances of the resulting double glazing unit in terms of PAR light transmission (expressed in %) and thermal insulation.

TABLE 1

| | | AR | Low-e | | |
|---|---|---|---|---|---|
| | Etched | coated | coated | | U |
| reference | sides | sides | sides | T_{PAR} (%) | (W/m² · K) |
| 1 | no | no | no | 84.3 | 2.6 |
| 2 | P4 | P4 | no | 86.4 | 2.6 |
| 3 | P4 | P1, P2, | no | 93.2 | 2.6 |
| | | P3, P4 | | | |
| 4 | P4 | P1 | P3 | 84.8 | 1.1 |
| 5 | P4 | P1, P4 | P3 | 87.0 | 1.1 |
| 6 | P4 | P1, P2, | P3 | 89.3 | 1.1 |
| | | P4 | | | |

The table above clearly shows that the glazing of the invention allows to improve the light transmission and more particularly the PAR light transmission, while keeping the thermal insulation at the same level.

1. A double glazing unit for a greenhouse, comprising:
an outside glass substrate with 2 main surfaces referenced as P1 and P2, and
an inside glass substrate with 2 main surfaces referenced as P3 and P4,
wherein, the P4 main surface of the inside glass substrate has a specific roughness, said specific roughness is characterized by a Sa parameter comprised between 0.18 and 1.80 μm, a Sz parameter comprised between 1.5 and 10.0 μm and a Rsm parameter comprised between 65 and 125 μm.

2. The double glazing unit of claim 1, wherein the P4 main surface is coated with an antireflective layer.

3. The double glazing unit of claim 2, wherein the antireflective layer deposited on P4 is a nano-porous silica layer having a thickness comprised between 80 and 150 nm, and has a refractive index which is at most 1.5.

4. The double glazing unit of claim 1, wherein the specific roughness is characterized by the Sa parameter being at least 0.18 μm, and being at most 1.8 μm.

5. The double glazing unit of claim 1, wherein the specific roughness is characterized by the Sz parameter being at least 2 μm, and being at most 10.0 μm.

6. The double glazing unit of claim 1, wherein the specific roughness is characterized by the Rsm parameter being at least 65 μm and being at most 125 μm.

7. The double glazing unit of claim 1, wherein the P1 surface is coated with an antireflective layer.

8. The double glazing unit of claim 7, wherein the P2 surface is coated with an antireflective layer.

9. The double glazing unit of claim 7, wherein the antireflective layer is a nano-porous silica layer having a thickness comprised between 80 and 150 nm and has refractive index of at most 1.5.

10. The double glazing unit of claim 1, wherein all main surfaces P1, P2, P3 and P4 are coated with an antireflective layer.

11. The double glazing unit of claim 10, wherein the antireflective layer is a nano-porous silica layer having a thickness comprised between 80 and 150 nm and has refractive index of at most 1.5.

12. The double glazing unit of claim 1, wherein the P3 main surface is coated with a low-e stack.

13. The double glazing unit of claim 12, wherein the low-e stack comprises successively from the P3 main glass surface, a first dielectric film, a silver layer and a second dielectric film.

14. The double glazing unit of claim 1, wherein a PAR transmittance is increased by at least 1.5% while keeping a thermal coefficient U expressed in W/m²·K unchanged.

15. The double glazing unit of claim 1, wherein a hortiscatter is comprised between 5 and 70%.

16. The double glazing unit of claim 1, wherein both glass substrates have a composition characterized by an iron content expressed in weight percent of Fe₂O₃ which is at most 0.1%.

17. The double glazing unit of claim 1, wherein the roughness is a consequence of a random texturing.

18. The double glazing unit of claim 2, wherein the antireflective layer deposited on P4 is a nano-porous silica layer having a thickness comprised between 100 and 120 nm and has a refractive index which is at most 1.4.

19. The double glazing unit of claim 1, wherein the specific roughness is characterized by the Sa parameter being at least 0.20 μm and at most 1.6 μm, the Sz parameter being at least 3 μm and at most 9.0 μm, and the Rsm parameter being at least 75 μm and at most 115 μm.

20. The double glazing unit of claim 1, wherein a PAR transmittance is increased by at least 2.0% while keeping a thermal coefficient U expressed in W/m²·K unchanged and a hortiscatter is comprised between 10 and 65.
